(19) United States
(12) Patent Application Publication
(10) Pub. No.: US 2009/0006342 A1
(43) Pub. Date: Jan. 1, 2009

(54) Method, Apparatus and Computer Program Product for Providing Internationalization of Content Tagging

(75) Inventors: Davin Wong, Helsinki (FI); Janne Kaasalainen, Helsinki (FI); Oleksandr Kononenko, Helsinki (FI); Hannu Mettala, Lapinkyla (FI); James Reilly, Helsinki (FI); Toni Strandell, Helsinki (FI); Carlos Miguel Quiroz Castro, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/768,347

(22) Filed: Jun. 26, 2007

(51) Int. Cl. G06F 17/30

(52) U.S. Cl. 707/4; 707/E17.062

(57) ABSTRACT

An apparatus for providing internationalization of content tagging may include a processing element. The processing element may be configured to receive an indication of content with respect to which a function is being performed, determine whether to translate metadata associated with the content, and translate the metadata based on the determination.

### TECHNOLOGICAL FIELD

Embodiments of the present invention relate generally to content management technology and, more particularly, relate to a method, device, mobile terminal and computer program product for providing internationalization of content tagging.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the storage capacity of such devices has allowed users to store very large amounts of content on the devices. Given that the devices will tend to increase in their capacity to store content, and given also that mobile electronic devices such as mobile phones often face limitations in display size, text input speed, and physical embodiments of user interfaces (UI), challenges are created in content management. Specifically, an imbalance between the development of stored content capabilities and the development of physical UI capabilities may be perceived.

In order to provide a solution for the imbalance described above, metadata and other content management enhancements have been developed. Metadata typically includes information that is separate from an object, but related to the object. An object may be “tagged” by adding metadata to the object. As such, metadata may be used to specify properties associated with the object that may not be obvious from the object itself. Metadata may then be used to organize the objects to improve content management capabilities. Additionally, some methods have been developed for inserting metadata based on context. Context metadata describes the context in which a particular content item was “created”. Hereinafter, the term “created” should be understood to be defined such as to encompass also the terms captured, received, and downloaded. In other words, content may be defined as “created” whenever the content first becomes resident in a device, by whatever means regardless of whether the content previously existed on other devices. However, some context metadata may remain unchanged when the corresponding content is transferred from one device to another. Context metadata can be associated with each content item in order to provide an annotation to facilitate efficient content management features such as searching and organization features. Accordingly, the context metadata may be used to provide an automated mechanism by which content management may be enhanced and user efforts may be minimized.

Currently, devices such as mobile terminals are becoming more and more adept at content creation (e.g., images, videos, product descriptions, event descriptions, etc.). As such, tagging of objects produced as a result of content creation has become a common practice to facilitate, for example, publishing and/or retrieval of content used in connection with multimedia sharing communities or other applications. In this regard, tags may be used, for example, to organize stored content or to serve as a basis for a search of related content items using a query defining a topic or characteristic of content that is desired for viewing and/or retrieval. Metadata or tags are often textual keywords used to describe the corresponding content with which they are associated. However, the tags are typically expressed in the native language of the creator of the content. Accordingly, the usage of tags may become confined based on the linguistic aptitude of creators and/or users of tagged content such as multimedia items.

The Internet serves as a catalyst for a diverse audience including people from numerous countries, with numerous languages, to share content such as videos, photos, etc. However, the diversity and dissimilarity of languages can, as alluded to above, often serve to impede effective content sharing since tags are typically language dependent. In this regard, tags are typically matched (e.g., for searching for content related to a particular query) based on their surface forms. In other words, the original form given by the user without any preprocessing. For example, a search for the term “cats” may only return results having the identical form (i.e., not terms sharing the same root, such as “cat”). Although certain types of pre-processing may be applied to canonicalize tags by stemming so that, for example, a search term of “computer” may be stemmed to the canonical form “comput” so that “computer” or “computers” and/or other words sharing the same root may also be searched, such pre-processing does not cover different languages. Thus, a search for content having metadata corresponding to the term “computer” would, in any case, not return results that are tagged with “dator” or “tietokone”, the Swedish and Finnish equivalents, respectively, of the English word “computer”.

Thus, it may be advantageous to provide an improved method of content tag treatment, which may provide improved content searching and/or organization.

### BRIEF SUMMARY

A method, apparatus and computer program product are therefore provided to enable internationalization of content tagging. In particular, a method, apparatus and computer program product are provided that provide for a determination as to whether and how to translate metadata or tags associated with content. In this regard, for example, in response to a function being performed with respect to a content item or object, a determination may be made as to whether to translate a tag associated with the content item or object into a language other than the current language of the tag. In an exemplary embodiment, the tag may be translated based on location information and/or a user profile although other criteria may also be utilized. The function being performed could be, for example, performing a search for content, viewing content, creating content, or other operations. Accordingly, the efficiency and universality of metadata usage may be increased and content management for devices such as mobile terminals may be improved.

In one exemplary embodiment, a method of providing internationalization of content tagging is provided. The method includes receiving an indication of content with respect to which a function is being performed, determining whether to translate metadata associated with the content, and translating the metadata based on the determination.

In another exemplary embodiment, a computer program product for providing internationalization of content tagging is provided. The computer program product includes at least one computer-readable storage medium having computer-readable program code portions stored therein. The computer-readable program code portions include first, second and third executable portions. The first executable portion is for receiving an indication of content with respect to which a function is being performed. The second executable portion is for determining whether to translate metadata associated with the content. The third executable portion is for translating the metadata based on the determination.

In another exemplary embodiment, an apparatus for providing internationalization of content tagging is provided. The apparatus may include a processing element. The processing element may be configured to receive an indication of content with respect to which a function is being performed, determine whether to translate metadata associated with the content, and translate the metadata based on the determination.

In another exemplary embodiment, an apparatus for providing internationalization of content tagging is provided. The apparatus includes means for receiving an indication of content with respect to which a function is being performed, means for determining whether to translate metadata associated with the content, and means for translating the metadata based on the determination.

Embodiments of the invention may provide a method, apparatus and computer program product for advantageous employment in content sharing/organizing environments including a mobile electronic device environment, such as on a mobile terminal capable of creating and/or viewing content items and objects related to various types of media. As a result, for example, mobile terminal users may enjoy an improved content management capability.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for providing internationalization of content tagging according to an exemplary embodiment of the present invention; and

FIG. 4 is a flowchart according to an exemplary method for providing internationalization of content tagging according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

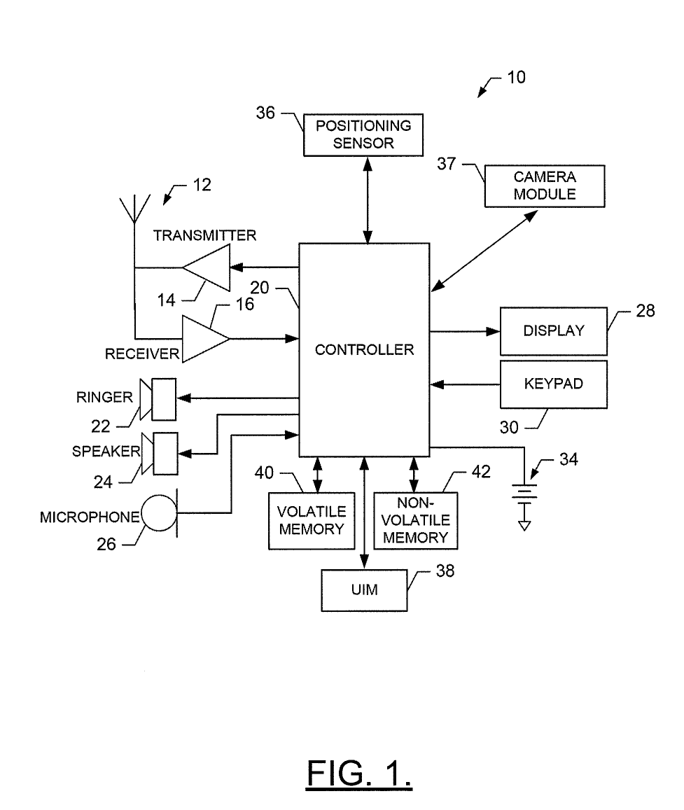

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as a position history or location information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 includes a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image. As such, the camera module 37 includes all hardware, such as a lens or other optical device, and software necessary for creating a digital image file from a captured image. Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to a JPEG standard format.

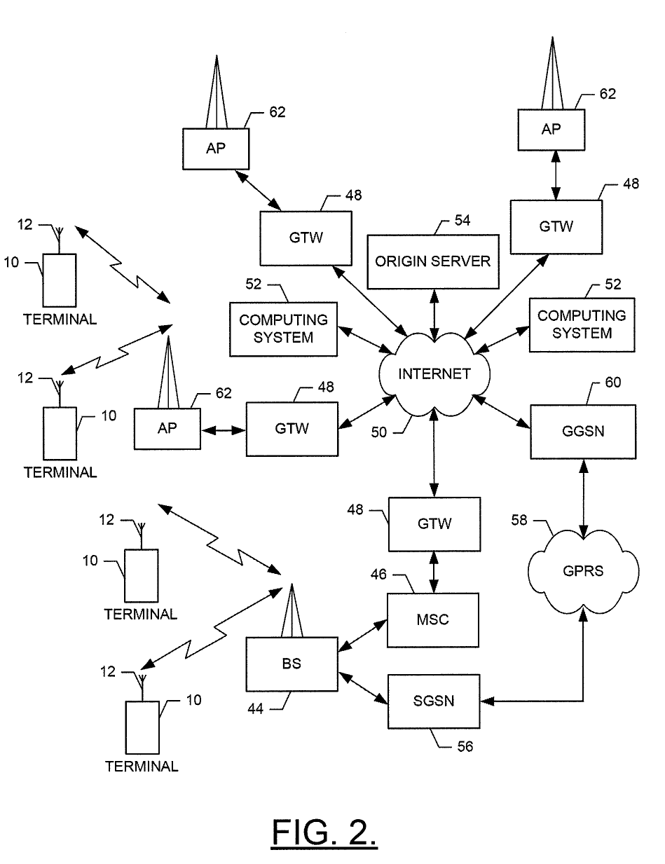

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

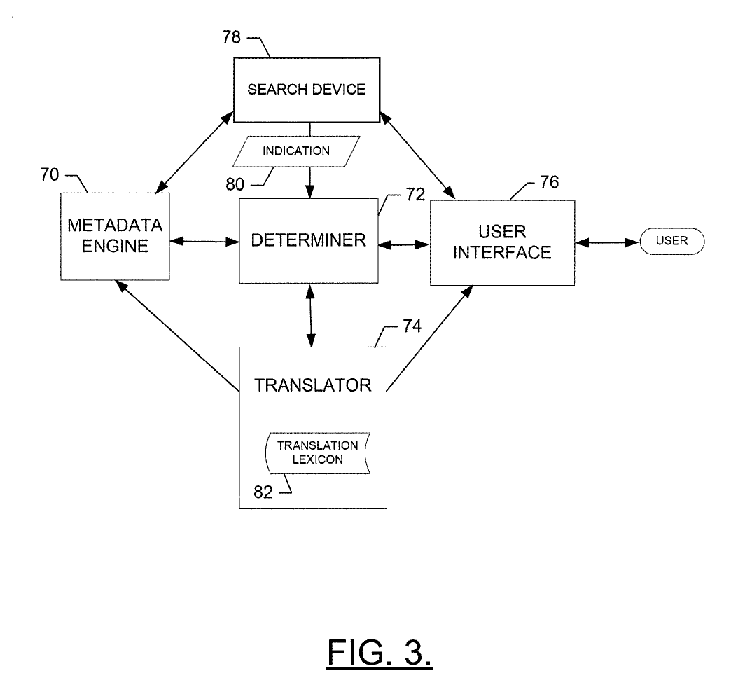

An exemplary embodiment of the invention will now be described with reference to FIG. 3, in which certain elements of a system for providing internationalization of content tagging are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. For example, the system of FIG. 3 may be employed on a personal computer, a camera, a video recorder, a server, a proxy, etc. Alternatively, embodiments may be employed on a combination of devices including, for example, those listed above. It should also be noted, however, that while FIG. 3 illustrates one example of a configuration of a system for providing content tagging for use, for example, in metadata-based content management, numerous other configurations may also be used to implement embodiments of the present invention.

Referring now to FIG. 3, a system for providing internationalization of content tagging is provided. The system may be embodied in hardware, software or a combination of hardware and software for use by a device such as the mobile terminal. The system may include a metadata engine 70, a determiner 72, and a translator 74. In an exemplary embodiment, the system may also include a user interface 76 and/or a search device 78. In some embodiments, one or more of the metadata engine 70, the determiner 72, the translator 74 and the search device 78 may be in communication with the user interface 76 via any wired or wireless communication mechanism. In this regard, for example, the user interface 76 may be in communication with at least the metadata engine 70 to enable the metadata engine 70 to generate metadata for content created in response to user instructions received via the user interface 76. For example, a user may utilize the user interface 76 in order to direct the operation of a device (e.g., the mobile terminal 10) to import a file, capture an image or video sequence, download a web page, generate a document, posting an entry to a weblog or journal, etc., to thereby create an object which may include any type of content and the metadata engine 70 may assign metadata to the created object for storage in association with the created object. In an exemplary embodiment, the metadata engine 70 may be in simultaneous communication with a plurality of applications or processes and may generate metadata for content created by each corresponding application or process. Examples of applications that may be in communication with the metadata engine 70 may include, without limitation, multimedia generation, phonebook, document creation, calendar, gallery, messaging client, location client, calculator, weblog, and other like applications.

Each of the metadata engine 70, the determiner 72, the translator 74, the user interface 76 and the search device 78 may be embodied as any device or means embodied in either hardware, software, or a combination of hardware and software that is capable of performing the corresponding functions of the metadata engine 70, the determiner 72, the translator 74, the user interface 76 and the search device 78, respectively, as described in greater detail below. As such, for example, the metadata engine 70, the determiner 72, the translator 74 and the search device 78 may each be controlled by or otherwise embodied as a processing element (e.g., the controller 20 or a processor of a server or computer). Processing elements such as those described herein may be embodied in many ways. For example, the processing element may be embodied as a processor, a coprocessor, a controller or various other processing means or devices including integrated circuits such as, for example, an ASIC (application specific integrated circuit).

It should be noted that any or all of the metadata engine 70, the determiner 72, the translator 74, the user interface 76 and the search device 78 may be collocated in a single device. For example, the mobile terminal 10 of FIG. 1 may include all of the metadata engine 70, the determiner 72, the translator 74, the user interface 76 and the search device 78. Alternatively, any or all of the metadata engine 70, the determiner 72, the translator 74, the user interface 76 and the search device 78 may be disposed in different devices. For example, the metadata engine 70, the determiner 72, the translator 74 and the search device 78 may be disposed at a server, while the user interface 76 may be disposed at a mobile terminal in communication with the server. As such, certain elements or devices of the system may operate in a client-server relationship with other elements or devices of the system. Other configurations are also possible.

The user interface 76 may include, for example, the keypad 30 and/or the display 28 and associated hardware and software. It should be noted that the user interface 76 may alternatively be embodied entirely in software, such as may be the case when a touch screen is employed for interface using functional elements such as software keys accessible via the touch screen using a finger, stylus, etc. As another alternative, the user interface 76 may be a simple key interface including a limited number of function keys, each of which may have no predefined association with any particular text characters. As such, the user interface 76 may be as simple as a display and one or more keys for selecting a highlighted option on the display for use in conjunction with a mechanism for highlighting various menu options on the display prior to selection thereof with the one or more keys. User instructions for the performance of a function may be received via the user interface 76 and/or an output such as by visualization of data may be provided via the user interface 76.

In an exemplary embodiment, the metadata engine 70 may be any device or means embodied in either hardware, software, or a combination of hardware and software configured to generate metadata according to a defined set of rules. The defined set of rules may dictate, for example, the metadata that is to be assigned to content created using a particular application or in a particular context, etc. As such, in response to receipt of an indication of event such as taking a picture or capturing a video sequence (e.g., from the camera module 37), the metadata engine 70 may be configured to assign corresponding metadata (e.g., a tag). Alternatively, the metadata engine 70 may be used to facilitate manual tagging of content by a creator of the content. In an exemplary embodiment, the metadata engine 70 may be in communication with either or both of the determiner 72 and the translator 74 in order to receive instructions related to metadata generation. In this regard, for example, the metadata engine 70 may be configured to receive instructions from either or both of the determiner 72 and the translator 74 regarding the assignment of and/or translation of metadata.

The search device 78 may be any device or means embodied in either hardware, software, or a combination of hardware and software configured to receive an input (e.g., a query) defining a characteristic of content which the user desires to receive as search results. For example, the query could be a text entry corresponding to at least a portion of a tag. Alternatively, the query could be identified by virtue of selecting a tag associated with a content item or a tag cloud. In this regard, metadata associated with content may be searched for the query and content including metadata having the text entry of the query (or the translated equivalent of the text entry of the query) may be returned to the user for viewing, download, etc. Results may be provided based on relevancy or any other criteria. The query may be input and results may be visualized via the user interface 76 or another device.

The determiner 72 may be any device or means embodied in either hardware, software, or a combination of hardware and software configured to extract and or receive an indication 80 such as event related information (e.g., content creation notification) or other indications (e.g., indications of search term (i.e., query) input, content sorting, content viewing operations, content publishing or sharing operations, etc.) of and relating to content with respect to which a function is being performed. The determiner 72 may be in communication with, for example, any of the metadata engine 70, other devices/components (e.g., the camera module 37), the search device 78, the user interface 76 or other applications in order to receive the indication 80 (although FIG. 3 only shows the indication being received from the search device 78 for exemplary purposes). Thus, for example, the indication 80 may be received from an application to indicate that content has been created. In this regard, for example, if an event is detected at the determiner 72 such as creation of an image or other visual media (e.g., by taking a picture with the camera module 37), the determiner 72 may communicate the event information to the metadata engine 70 for assignment of metadata to the object associated with the event information.

As an alternative (or as an additional feature), the determiner 72 may be configured to determine whether to translate metadata. In an exemplary embodiment, the determiner 72 may be configured to make the determination with regard to whether to translate metadata based at least in part on the function being performed on the content. In this regard, the determiner 72 may be configured to determine whether to translate content based, for example, on whether the function is a search operation, content sorting, content viewing, content creation, etc. Thus, for example, different translation guidelines or criteria may apply to different functions being performed with respect to the content. Information regarding the function being performed on the content could be received, for example, from one or more of the metadata engine 70, the search device 78, the user interface 76 or another device or application performing a function on the content.

In another exemplary embodiment, the determination with respect to translation may depend on other criteria. For example, the determiner 72 may be configured to determine whether to instruct the translator 74 with respect to translation of the metadata that is already or would otherwise be associated with the content based on context information or location information such as the location of the device creating or otherwise performing a function on the content. As an example, if content is created in Japan by a native English speaker, the determiner 72 may be configured to determine whether to instruct the translator 74 to translate the metadata to be assigned to the created content into Japanese. Alternatively, if a content search is being conducted in Japan by a native English speaker, the query entered by the native English speaker may be translated into Japanese based on a determination by the determiner 72 with regard to device location, and both the English and Japanese queries (stemmed or otherwise) may be utilized in connection with the search for content relevant to the queries (e.g., having matching characters or stems). Predefined criteria may govern the operation of the determiner 72 in this regard. For example, the determiner 72 may include default, factory installed criteria or user alterable criteria (e.g., which may be entered via a user interface console or toolbar/menu option). As such, the determiner 72 of some embodiments may be configured to determine whether to direct translation of metadata based directly upon user preference or user defined criteria.

As indicated above, context information may also be used by the determiner 72 in making translation determinations. In this regard, context could be used e.g., to resolve ambiguities related to some words since the same word (tag) may have more than one meaning. Context (or other mechanisms such as user input) may even be used to select a specific translation lexicon, such as business or technical, or among several user updated translation lexicons (for e.g. different contexts or domains).

The translator 74 may be any device or means embodied in either hardware, software, or a combination of hardware and software configured to translate text from a first language into a second language. In response to receipt of instructions from the determiner 72, the translator 74 may perform a translation of, for example, a tag or metadata. The translator 74 may be configured to perform translations between any number of known languages. A determination as to which languages are to be supported may be based on user preference, factory installation, device limitations, or numerous other factors. Language modules (e.g., support for additional languages, or improved support for currently supported languages) may further be upgraded or otherwise altered either wirelessly or via a wired connection with, for example, a service provider. Language modules may be upgraded or altered by user request, or independent operator action.

In an exemplary embodiment, the translator 74 may be configured to perform multi-lingual automatic translation of metadata or tags based on the determination of the determiner 72. In this regard, the translator 74 may include a translation lexicon 82 which may be stored in a memory of the translator 74 or a memory device accessible to the translator 74 (e.g., locally via the volatile memory 40 or the non-volatile memory 42 or externally via a network connection). The translation lexicon 82 may enable cross translation of tags between supported languages, for example, by looking up parallel words in one or more different languages for a target word (e.g., a text word or text entry in a metadata tag). The parallel words may be defined as translations of the target word in one or more different languages. While direct translation of the target word may be utilized for determining parallel words, some embodiments may alternatively or additionally provide expansion beyond direct translation such as, for example, translation of synonyms of the target word. In an exemplary embodiment, if no translation is available for a particular target word, synonyms may be determined in order to pursue translation of the synonyms to increase the possibility of achieving a translation.

The determiner 72 and/or a user profile may provide the translator 74 with particular instructions regarding which languages are to be used for translation. Alternatively, the translator 74 itself may store instructions regarding, for example, rules for translation of metadata. In an exemplary embodiment, the determiner 72 may be configured to instruct the translator 74 to automatically translate metadata in response to receipt of the indication 80. However, as indicated above, other criteria may also be included for initiating translation of metadata. Regardless of how the initiation of metadata is accomplished, the translator 74 may be configured to provide a variety of output possibilities. In this regard, for example, the translator 74 may be configured to automatically provide one or more translation options to one or more of the metadata engine 70, the user interface 76 or the search device 78 for use in connection with the performance of the corresponding functions of the metadata engine 70, the user interface 76 and the search device 78 with respect to the content. Alternatively or additionally, the translator 74 may be configured to store one or more translation options after such options are determined until a particular function is performed. For example, the translator 74 may be configured to automatically determine translation options for a tag into one or more languages upon creation of content receiving the tag. However, the translation options may be stored until such time as the corresponding content is viewed or published (e.g., shared), at which time the translation options may be appended to the existing tag or offered to the user for selection to be appended to the existing tag. As another example, translation options may be determined according to a predefined rule automatically, but only offered as options for the user to select to be appended to existing tag information in response to predefined criteria being met. In other words, the translation options may be determined transparent to the user and stored until predefined criteria are met, at which time the user may be presented with one or more translation options. Numerous other options also exist in this regard, based on predefined criteria associated with the translator 74. In an exemplary embodiment, selection of translation options may be performed via the user interface 76.

Another option with regard to translator 74 operation may include the number of translation options either determined or presented to the user. For example, a predetermined number of translation options may be determined by the translator 74 and a same or different number of translation options may be presented to the user. Alternatively, the translator 74 may be configured to select one translation option among a plurality of translation options having a highest probability of being a correct or desirable translation.

In an exemplary embodiment, the translation lexicon 82 may include stored parallel tags in a plurality of different languages, for example, such that each tag includes corresponding parallel tags in one or more different languages. However, since correspondence between tags in different languages may not be one-to-one given that some words have more than one meaning, the translation lexicon 82 may not necessarily include translations for all possible tags. For example, the translation lexicon 82 may include only a certain set of commonly used tags. As such, the size and/or cost associated with the translation lexicon 82 may be varied according to cost/benefit or other considerations. In this regard, the translation lexicon 82 may include a predefined set of candidates including, for example, the n-most common tags found for pair-wise sets of languages. As such, for example, only the most common tags in both of each set of pair-wise languages may be included in the translation lexicon 82.

In an exemplary embodiment, a tag cloud including a visual display of weighted terms, words or text entries by popularity for a first language (e.g., English), and a tag cloud for a second language (e.g., Finnish) may be used to select a predefined number (e.g., 10, 100, 1000, etc.) most common tags found in both tag clouds based on usage of the tags within a predefined period of time (e.g., the last year). Translations of the selected most common tags may then be provided for those tags having translation matches in both sets, and which are not identical strings. Tag translations may also be provided for the most common tag queries. The process above may then be repeated for any number of languages such as, for example, the n-most common languages, or the n-most likely languages to be encountered based on the location of the device employing an embodiment of the present invention.

In an exemplary embodiment, users may be given an ability to add, modify and/or delete entries within the translation lexicon 82. Thus, for example, if a new term comes into common usage, the user may enter such term into the translation lexicon 82. In an exemplary embodiment, the user could also provide corresponding translations for any entries the user modifies or adds. In another exemplary embodiment, a network device may monitor tag usage relative to content communicated via the network in order to provide updates to the translation lexicon 82 on the basis of information determined relative to all or a selected portion of tags associated with content shared via the network.

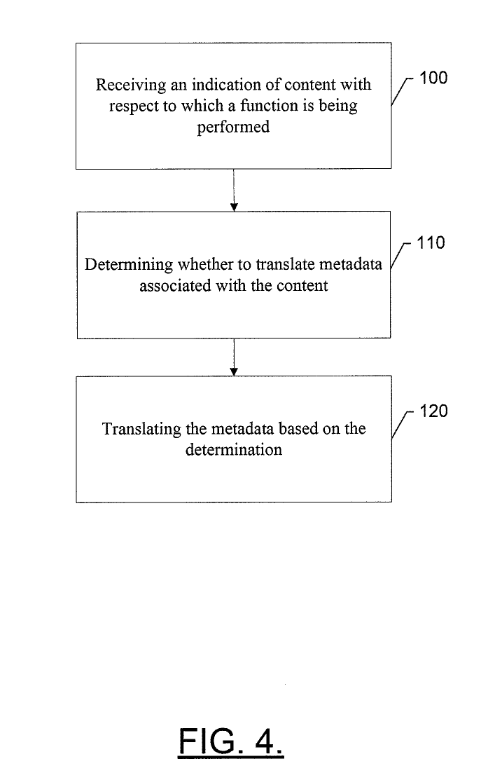

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing internationalization of content tagging may include receiving an indication of content with respect to which a function is being performed at operation 100. In various exemplary embodiments, the indication may be an indication of a content search operation, an indication of a content viewing operation, an indication of a content creation operation, etc. At operation 110, a determination may be made as to whether to translate metadata associated with the content. If the function is a content search, determining whether to translate the metadata may include determining whether to translate a metadata query term for conducting a content search. The determination may be made on the basis of, for example, information in a user profile, context information or location information. The determination may alternatively be made based at least in part on the type of function being performed on the content. The metadata may be translated based on the determination at operation 120. The translation may be performed based on a user updated translation lexicon or a predefined translation lexicon. The predefined lexicon may be, for example, a multi-lingual tag lexicon including at least corresponding tag options from two different languages in which the corresponding tag options are predetermined based on a correlation between most commonly used tags in each of the two different languages. In an exemplary embodiment, the translation may include translating the metadata from a first language to a second language and presenting the translated metadata to a user as a translation option. In one example, the content may then be tagged responsive to a user selection of the translation option. However, as an alternative, the translation may be handled internally and not necessarily be visible to the user.

It should be noted that although exemplary embodiments discuss content, the content may include objects or items such as, without limitation, image related content items, video files, television broadcast data, text, documents, web pages, web links, audio files, radio broadcast data, broadcast programming guide data, location tracklog information, etc.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of content with respect to which a function is being performed;
determining whether to translate metadata associated with the content; and
translating the metadata based on the determination.

2. A method according to claim 1, wherein receiving the indication comprises receiving an indication of a search operation and wherein determining whether to translate the metadata comprises determining whether to translate a metadata query term for conducting a content search.

3. A method according to claim 1, wherein receiving the indication comprises receiving an indication of a content viewing operation.

4. A method according to claim 1, wherein receiving the indication comprises receiving an indication of a content creation operation.

5. A method according to claim 1, wherein determining whether to translate metadata further comprises determining a location of a device performing the function and determining whether to translate the metadata based at least in part on the location.

6. A method according to claim 1, wherein determining whether to translate metadata comprises determining whether to translate the metadata based at least in part on a user profile or context information.

7. A method according to claim 1, wherein translating the metadata comprises translating the metadata based on a user updated translation lexicon.

8. A method according to claim 1, wherein translating the metadata comprises translating the metadata based on a predefined translation lexicon.

9. A method according to claim 8, further comprising defining the predefined translation lexicon as a multi-lingual tag lexicon including at least corresponding tag options from two different languages, wherein the corresponding tag options are predetermined based on a correlation between most commonly used tags in each of the two different languages.

10. A method according to claim 1, wherein translating the metadata comprises translating the metadata from a first language to a second language and presenting the translated metadata to a user as a translation option.

11. A method according to claim 10, further comprising tagging the content responsive to a user selection of the translation option.

12. A computer program product comprising at least one computer-readable storage medium having computer-readable program code portions stored therein, the computer-readable program code portions comprising:
a first executable portion for receiving an indication of content with respect to which a function is being performed;
a second executable portion for determining whether to translate metadata associated with the content; and
a third executable portion for translating the metadata based on the determination.

13. A computer program product according to claim 12, wherein the first executable portion includes instructions for receiving an indication of a search operation and wherein the second executable portion includes instructions for determining whether to translate a metadata query term for conducting a content search.

14. A computer program product according to claim 12, wherein the first executable portion includes instructions for receiving an indication of a content viewing operation.

15. A computer program product according to claim 12, wherein the first executable portion includes instructions for receiving an indication of a content creation operation.

16. A computer program product according to claim 12, wherein the second executable portion includes instructions for determining a location of a device performing the function and determining whether to translate the metadata based at least in part on the location.

17. A computer program product according to claim 12, wherein the second executable portion includes instructions for determining whether to translate the metadata based at least in part on a user profile or context information.

18. A computer program product according to claim 12, wherein the third executable portion includes instructions for translating the metadata based on a user updated translation lexicon.

19. A computer program product according to claim 12, wherein the third executable portion includes instructions for translating the metadata based on a predefined translation lexicon.

20. A computer program product according to claim 19, further comprising a fourth executable portion for defining the predefined translation lexicon as a multi-lingual tag lexicon including at least corresponding tag options from two different languages, wherein the corresponding tag options are predetermined based on a correlation between most commonly used tags in each of the two different languages.

21. A computer program product according to claim 12, wherein the third executable portion includes instructions for translating the metadata from a first language to a second language and presenting the translated metadata to a user as a translation option.

22. A computer program product according to claim 21, further comprising a fourth executable portion for tagging the content responsive to a user selection of the translation option.

23. An apparatus comprising a processing element configured to:
receive an indication of content with respect to which a function is being performed;
determine whether to translate metadata associated with the content; and
translate the metadata based on the determination.

24. An apparatus according to claim 23, wherein the processing element is further configured to receive an indication of a search operation and to determine whether to translate a metadata query term for conducting a content search.

25. An apparatus according to claim 23, wherein the processing element is further configured to receive an indication of a content viewing operation.

26. An apparatus according to claim 23, wherein the processing element is further configured to receive an indication of a content creation operation.

27. An apparatus according to claim 23, wherein the processing element is further configured to determine a location of a device performing the function and determine whether to translate the metadata based at least in part on the location.

28. An apparatus according to claim 23, wherein the processing element is further configured to determine whether to translate the metadata based at least in part on a user profile or context information.

29. An apparatus according to claim 23, wherein the processing element is further configured to translate the metadata based on a user updated translation lexicon.

30. An apparatus according to claim 23, wherein the processing element is further configured to translate the metadata based on a predefined translation lexicon.

31. An apparatus according to claim 30, wherein the processing element is further configured to define the predefined translation lexicon as a multi-lingual tag lexicon including at least corresponding tag options from two different languages, wherein the corresponding tag options are predetermined based on a correlation between most commonly used tags in each of the two different languages.

32. An apparatus according to claim 23, wherein the processing element is further configured to translate the metadata from a first language to a second language and presenting the translated metadata to a user as a translation option.

33. An apparatus according to claim 32, wherein the processing element is further configured to tag the content responsive to a user selection of the translation option.

34. An apparatus comprising:
means for receiving an indication of content with respect to which a function is being performed;
means for determining whether to translate metadata associated with the content; and
means for translating the metadata based on the determination.

35. An apparatus according to claim 34, wherein means for translating the metadata comprises means for translating the metadata from a first language to a second language and presenting the translated metadata to a user as a translation option.

36. An apparatus according to claim 35, further comprising means for tagging the content responsive to a user selection of the translation option.
